(19) United States
(12) Patent Application Publication
(10) Pub. No.: US 2012/0173454 A1
(43) Pub. Date: Jul. 5, 2012

(54) FINANCIAL PORTFOLIO BOOST EVALUATION

(75) Inventors: Charles SHAH, Sunnyvale, CA (US); Sahib Bal, San Jose, CA (US); Anand Joshi, Mountain View, CA (US)

(73) Assignee: Yahoo! Inc., Sunnyvale, CA (US)

(21) Appl. No.: 12/980,362

(22) Filed: Dec. 29, 2010

(51) Int. Cl. G06Q 40/00

(52) U.S. Cl. 705/36 R

(57) ABSTRACT

A method associates a financial portfolio with a social network. The method calculates a normalized change in equity value for the financial portfolio. Also, the method displays a message on the social network based on the calculated change.

### BACKGROUND

1. Technical Field

Embodiments of the invention relate generally to financial applications, and more specifically, to normalizing portfolio values in a financial application.

2. Prior Art

Many people use computers and the Internet to manage and track financial investments. The Internet provides a medium for effortless updates of stock market prices in substantially real time. Some financial service providers allow users to track their portfolios with periodic updates of equity value and individual prices.

Problematically, when a user makes a change to their financial investment, the overall equity value changes. The change in equity value skews performance tracking because the assets have changed.

In a separate arena, social networking is an emerging application on the Internet. Users are able to send short messages about their personal activities to friends through status updates. Some users may want to boast about their performance on an investment portfolio. This can be done manually, but may become burdensome to do so at regular intervals. Additionally, self-gratifying messages from users may be viewed as having no authenticity, and consequentially, no credibility.

In the light of the foregoing discussion, there is a need for automatically displaying messages on a social network about normalized performance of an investment portfolio.

### SUMMARY

The above-mentioned needs are met by a method, computer program product and system for displaying messages on a social network about normalized performance of an investment portfolio.

In one embodiment, a method associates a financial portfolio with a social network. The method calculates a normalized change in equity value for the financial portfolio. Also, the method displays a message on the social network based on the calculated change.

In another embodiment, an interface to associate a financial portfolio with a social network. Further, a calculator module, coupled to the interface, the calculator module calculating a normalized change in equity value for the financial portfolio. The interface sends a message on the social network based on the calculated change

Advantageously, a user can automatically provide investment performance updates without skew from an authentic source (e.g., Yahoo! Finance).

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a flow chart illustrating a method for displaying financial portfolio messages on a social network according to an embodiment.

FIG. 2 is a flow chart illustrating a method for calculating a normalized change in equity value according to an embodiment.

FIG. 3 is a flow chart illustrating a method for determining messages to display on a social network based on the calculation according to an embodiment.

FIG. 4 is a block diagram illustrating a system to display financial portfolio messages on a social network according to an embodiment.

FIG. 5 is a block diagram illustrating a computing device in accordance to an embodiment.

FIG. 6 is a block diagram illustrating an application server in accordance to an embodiment.

FIG. 7 is a block diagram of a financial application module according to an embodiment.

### DETAILED DESCRIPTION

The above-mentioned needs are met by a method, computer program product and system for displaying financial application messages on a social network. The following detailed description is intended to provide example implementations to one of ordinary skill in the art, and is not intended to limit the invention to the explicit disclosure, as one or ordinary skill in the art will understand that variations can be substituted that are within the scope of the invention as described.

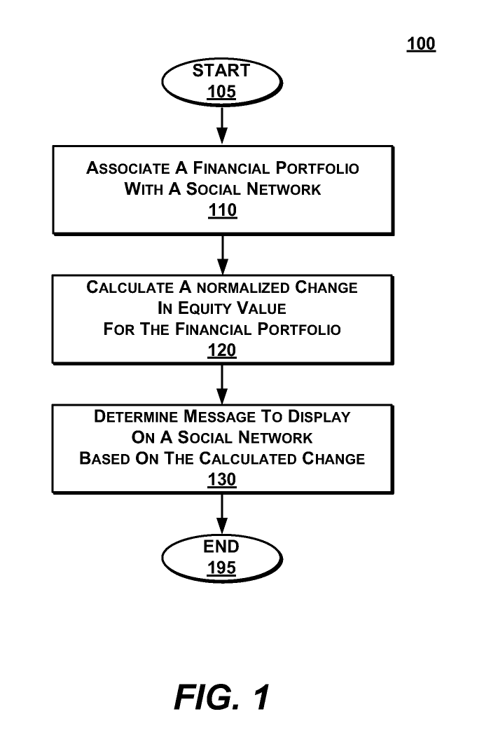

FIG. 1 is a flow chart illustrating a method 100 for displaying financial portfolio messages on a social network according to an embodiment.

At step 110, a financial portfolio is associated with a social network. A financial portfolio generally refers to a collection of investments held by an individual or entity. The investments have an equity value that changes over time. Exemplary investments include holdings in the stock or bond market, commodities, real estate, currency, and the like. Equity values for the investments can be determined by many ways. For example, many stocks that are public can be priced according to the New York Stock Exchange (NYSE), many commodity derivatives can be priced according to the Chicago Mercantile Exchange (CME), real estate can be priced according to estimated using an appraiser or appraisal web sites such as Zillow (http://www.zillow.com).

A financial portfolio can be real or virtual. A real portfolio can be set up through financial service web sites such as E-Trade (http://www.etrade.com) and AmeriTrade (http://www.ameritrade.com). These web sites allow users to buy and sell assets on public markets via the Internet. Additionally, web sites such as Yahoo! Finance (http://www.yahoo.com) allow users to set up virtual portfolios using fake money. Users can then practice buying and selling without risking actual money.

An equity value of the financial portfolio including stocks is determined by a price per share and a number of shares. The price per share is determined by the markets as described above. As the NYSE determines that a share price changes, there is a resulting change in equity value. The changes can occur continuously or at discrete time increments (e.g., hourly, daily or annually). In other markets such as the housing market, prices may change less frequently. Further, the price changes can be less specific. Housing appraisal values are often opinions and can vary based on the appraisal source.

The portfolio is associated with a social application using a linking technology such a Facebook Connect. Facebook (http://www.facebook.com) is a social networking web site that includes status updates for users of the service. A status update is a microblog of information relative to a user that is displayed to friends of the user. Facebook Connect allows a third party application, such as a financial portfolio application, to automatically post status updates to a user profile. A user can provide log-on credentials for authentication and provide consent for the automatic postings. The techniques described herein can be implemented in many other social networks such as Yahoo! Profile, Google Buzz, Twitter, and the like. Moreover, ad hoc social networks such as e-mail groups, SMS contacts, and the like can receive automatic updates.

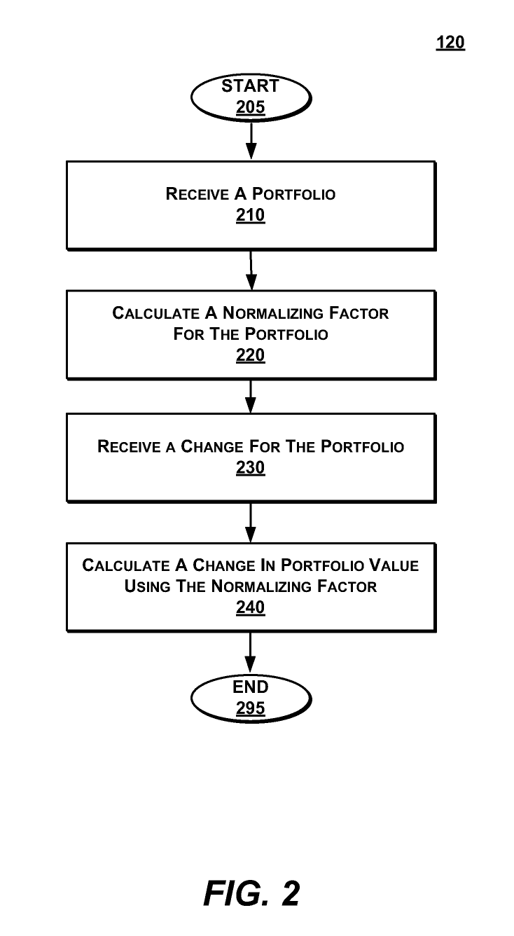

At step 120, a change in equity value is calculated for a financial portfolio. The equity value calculation is normalized to account for changes in the portfolio. When the components of a portfolio are constant, equity value is calculated by a change in price per share. However, when the components change, the equity value is normalized to prevent artificial inflations (or deflations) in equity value. For example, a user can purchase a new stock or sell an existing stock, or portions thereof. The resulting change in equity value would be artificially skewed without normalizing. Additional embodiments of step 120 are discussed below with respect to FIG. 2.

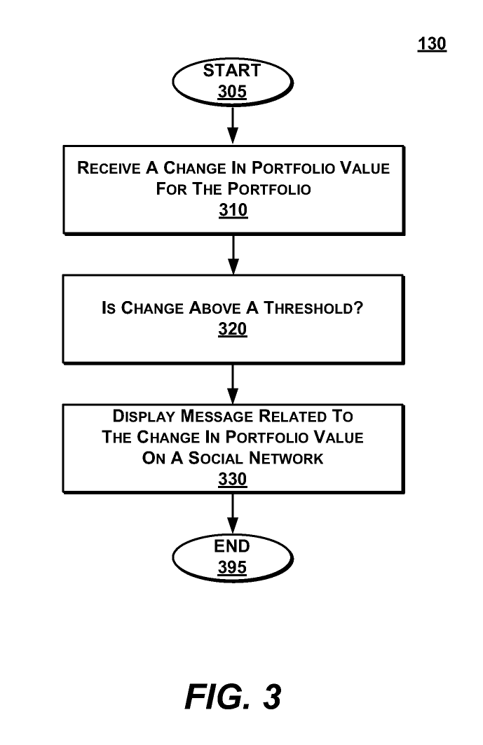

At step 130, a message to display on a social network is determined. The message is based on a calculation of equity value as described herein. One type of message can brag about an increase in equity value. For example, “VERONICA'S PORTFOLIO ON YAHOO! FINANCE INCREASED 10%!!!” However, many other types of messages are possible. The messages can be limited to a sub-set of friends, such as those involved in a financial portfolio competition. Additional embodiments of step 130 are discussed below with respect to FIG. 3.

FIG. 2 is a flow chart illustrating an example of the method 120 for calculating a normalized change in equity value according to an embodiment. Many implementation-specific variations are possible.

At step 210, a portfolio is received. The portfolio can be input by a user of a computing device. A graphical user interface (GUI) displayed by, for example, a web page, can facilitate input of stock holdings. An assist can be provided to look up precise codes for stocks (e.g., code for Yahoo, Inc. is YHOO).

At step 220, a normalizing factor (n) for the portfolio is calculated. An initial portfolio value (PV) is used to derive an initial normalizing factor. In general, the normalizing factor makes subsequent changes in equity value relative to the initial portfolio value of 100.

More specifically, PV=(1/n)(v1+v2+ . . . vx) where v is an equity value for stocks 1 through x. Therefore, n=(v1+v2+ . . . vx)/PV.

In one example, a user stock holding includes Yahoo (YHOO), Google (GOOG) and Apple (APPL), having hypothetical equity values of 15, 450 and 250. As a result, n=(15+450+250)/100=7.15.

When there is a change in equity values, without a change in stock holdings, a change is calculated by inserting the new stock values and the same normalizing factor. In our example, YHOO, GOOG and APPL have corresponding updated hypothetical equity values of 18, 400 and 245. As a result, PV=(1/7.15)(18+400+245)=92.72. The change in portfolio value is calculated to be 92.72-100=−7.36. In other words, the portfolio lost 7.36% in equity value. The portfolio value of 92.72 is carried forward for subsequent calculations for equity value.

At step 230, a change for the portfolio is received. The change represents a buy and/or sale of a portfolio asset. In our example, a user adds stock for Research in Motion (RIMM) which has a hypothetical equity value of 55.

At step 240, a change in portfolio value is calculated. The calculation is normalized using the normalizing factor to prevent artificial skewing.

Continuing with the example, an updated normalizing factor is calculated as n=(18+400+245+55)/92.72=7.743. Subsequent portfolio values are calculated using the updated normalizing factor. This causes the subsequent portfolio value to be relative to the initial portfolio value calculated in step 210, rather than being artificially increased due to the additional equity added by the RIMM stock.

FIG. 3 is a flow chart illustrating an example of the method 130 for determining messages to display on a social network based on the calculation according to an embodiment.

At step 310, a change in portfolio value for the portfolio is received.

At step 320, a change is evaluated to determine if it exceeds a threshold. During configuration, a user can determine when and which changes to report. In some cases, a user may want to report positive changes and disregard negative ones. In a game of several competitors, the configuration can be automatically determined by a policy of the game. A threshold can be set to prevent unnecessary spamming. Stock prices can change every second, and a user that reports each of the resulting changes in portfolio value can become a burden to social network friends. In one example, changes that increase or decrease a portfolio value by 10% or more are reported.

At step 330, a message related to a change in portfolio value is displayed on a social network. The message displayed can be default messages set up by the financial application. Furthermore, an icon associated with the application and an avatar associated with the user can also be displayed. In other embodiments, messages can be customized by a user.

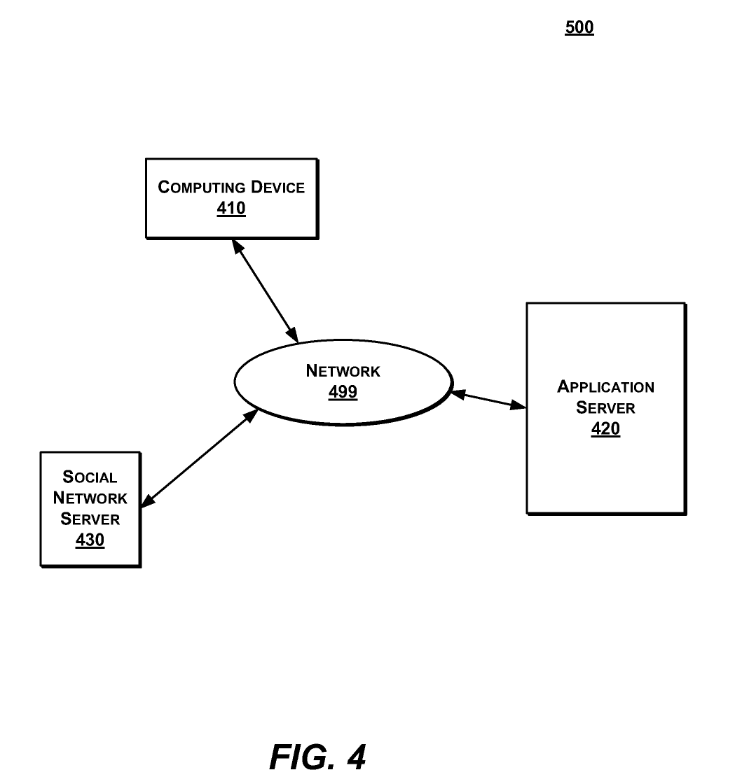

FIG. 4 is a block diagram illustrating a system 400 to display financial portfolio messages on a social network according to an embodiment. The system 400 can implement methods discussed above. The system 400 includes a computing device 410, an application server 420, and a social network server 430 coupled in communication through a network 499 (e.g., the Internet or a cellular network).

The computing device 410 can be, for example, a PC, a stationary computing device, a laptop or notebook computer, a tablet computer, a smart phone or PDA, a smart appliance, a video gaming console, an Internet television, a set-top box, or any other suitable processor-based device that can send view advertisements. There can be numerous computing devices 410 used by different users. In one embodiment, the computing device 410 allows a user to manage both a financial portfolio and interact with a social network. Additional embodiments of the computing device 510 are described in more detail below.

The application server 420 can be one or more of any of the above processor-based devices. In one embodiment, application server hosts a financial application, and can also host additional applications. Additional embodiments of the application server 410 are described in more detail below.

The social network server 430 can be one or more of any of the above processing-based devices. In one embodiment, the social network server 430 hosts a social networking web site such as Yahoo! Profile, Facebook or Twitter. In one embodiment, the social network server 430 and the application server 420 can be part of a single device, or be operated by a single entity. In other embodiments, they are separately maintained.

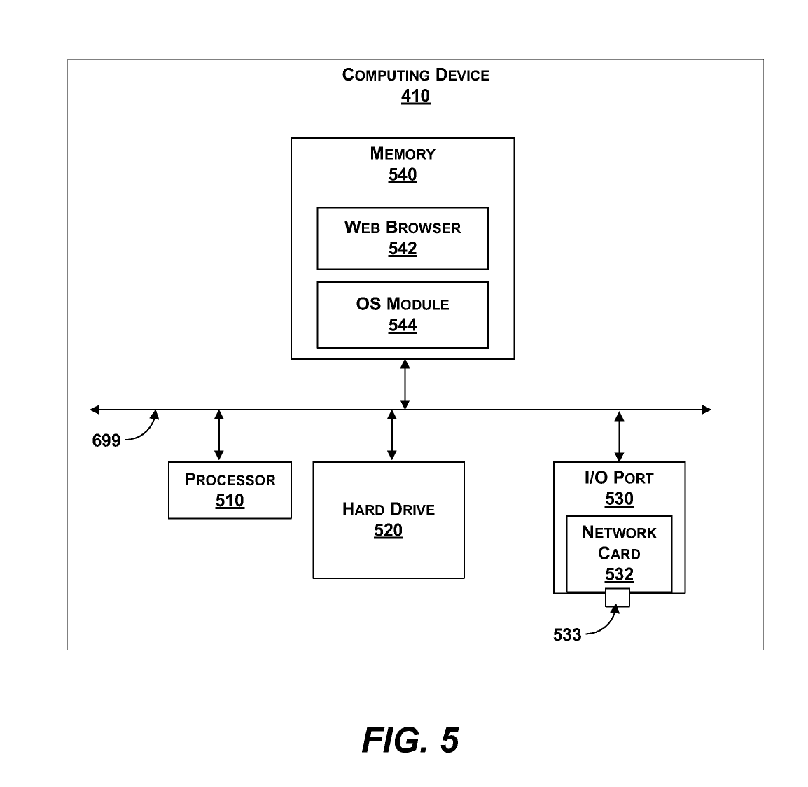

FIG. 5 is a block diagram illustrating a computing device 410 in accordance to an embodiment. The computing device 410 includes a processor 510, a hard drive 520, an I/O port 530, and a memory 540 coupled by a bus 599.

The bus 599 can be soldered to one or more motherboards. The processor 510 can be a general purpose processor, an application-specific integrated circuit (ASIC), an FPGA (Field Programmable Gate Array), a RISC (Reduced Instruction Set Controller) processor, an integrated circuit, or the like. There can be a single core, multiple cores, or more than one processor. In one embodiment, the processor 510 is specially suited for the processing demands of displaying advertisements (e.g., custom micro-code, instruction fetching, pipelining or cache sizes). The processor 510 can be disposed on silicon or any other suitable material. In operation, the processor 510 can receive and execute instructions and data stored in the memory 540 or the hard drive 520. The hard drive 520 can be a platter-based storage device, a flash drive, an external drive, a persistent memory device, or any other type of memory.

The hard drive 520 provides persistent (i.e., long term) storage for instructions and data. The I/O port 520 is an input/output panel including a network card 522. The network card 522 can be, for example, a wired networking card (e.g., a USB card, or an IEEE 802.3 card), a wireless networking card (e.g., an IEEE 802.11 card, or a Bluetooth card), a cellular networking card (e.g., a 3G card). An interface 523 is configured according to networking compatibility. For example, a wired networking card includes a physical port to plug in a cord, and a wireless networking card includes an antennae. The network card 522 provides access to a communication channel on a network.

The memory 540 can be a RAM (Random Access Memory), a flash memory, a non-persistent memory device, or any other device capable of storing program instructions being executed. The memory 540 further comprises a web browser 542, and an OS (operating system) module 544. The OS module 544 can be one of the Microsoft Windows® family of operating systems (e.g., Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64.

The web browser 542 can be a desktop web browser (e.g., Internet Explorer, Mozilla, or Chrome), a mobile browser, or a web viewer built integrated into an application program. In an embodiment, a user accesses a system on the World Wide Web (WWW) through a network such as the Internet. The web browser 542 is used to download web pages or other content in various formats including HTML, XML, text, PDF, and postscript, and may be used to upload information to other parts of the system. The web browser 642 may use URLs to identify resources on the web and HTTP (HyperText Transfer Protocol) in transferring files on the web. In one embodiment, the web browser 542 allows a user to manage financial portfolios and social networking.

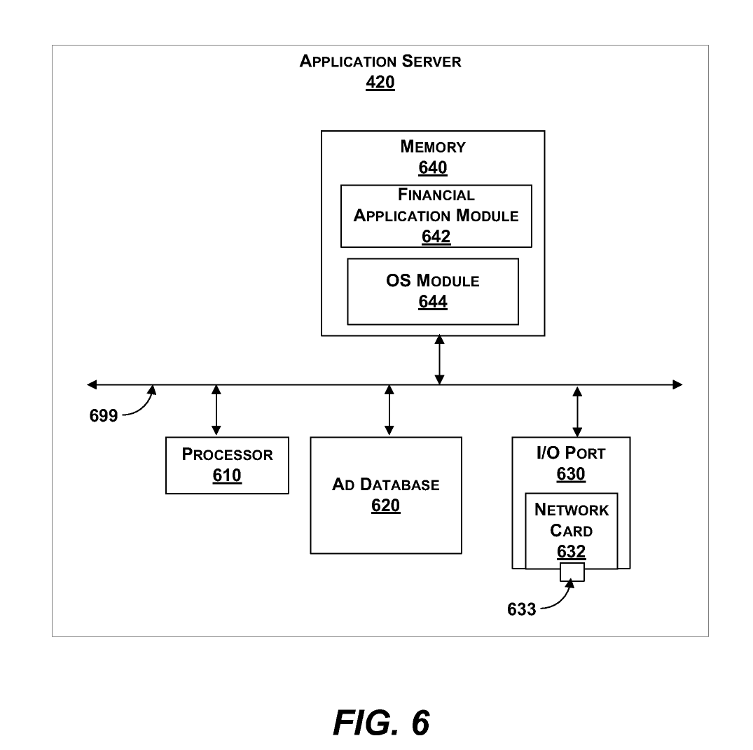

FIG. 6 is a block diagram illustrating an application server 520 in accordance to an embodiment. The application server 520 includes a processor 610, an advertisement database 620, an I/O port 630, and a memory 640, coupled by a bus 699. The processor 610, a hard drive 620, and the I/O port 630 can be configured as described above with respect to FIG. 5.

The memory 640 comprises an OS module 644, as described above, along with a financial application module 642. The financial application module 642 track a portfolio value for a user and report changes to the social network server 430 of FIG. 4. The financial application module 642 is described in more detail below.

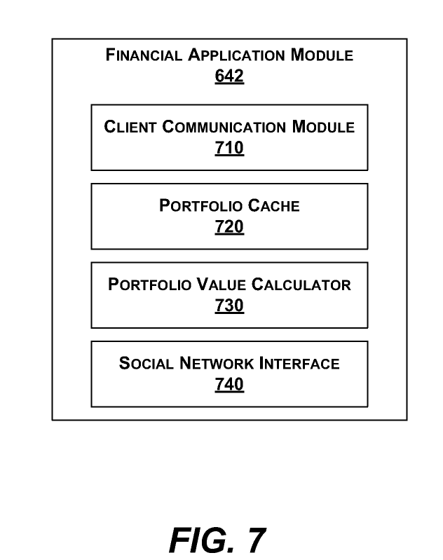

FIG. 7 is a block diagram of a financial application module 642 according to an embodiment. The financial application module 642 includes a client communication module 710, a portfolio cache 720, a portfolio value calculator 730 and a social networking interface 740. The components can communicate with each other through, for example, APIs (Application Programming Interfaces). In other embodiments, all or parts of the components can be implemented in hardware or benefit from special hardware accelerators.

In one embodiment, the client communication module 710 sends and receives information from the computing device 410 of FIG. 4 by providing a GUI. The portfolio cache 720 stores portfolio information such as portfolio values. The portfolio value calculator 730 uses a normalization factor to calculate relative equity values of portfolios. The social network interface 740 interacts with a social network to report messages as described herein.

As described herein, computer software products may be written in any of various suitable programming languages, such as C, C++, C#, Pascal, Fortran, Perl, Matlab (from MathWorks), SAS, SPSS, JavaScript, AJAX, and Java. The computer software product may be an independent application with data input and data display modules. Alternatively, the computer software products may be classes that may be instantiated as distributed objects. The computer software products may also be component software such as Java Beans (from Sun Microsystems) or Enterprise Java Beans (EJB from Sun Microsystems). Many of the functionalities described herein can be implemented in computer software, computer hardware, or a combination.

Furthermore, the computer that is running the previously mentioned computer software may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A computer-implemented method for tracking a normalized portfolio value, comprising:
associating a financial portfolio with a social network;
calculating a normalized change in equity value for the financial portfolio; and
displaying a message on the social network based on the calculated change.

2. The method of claim 1, wherein calculating the normalized change comprises:
calculating a normalizing factor for the portfolio based on an arbitrary initial portfolio value.

3. The method of claim 2, wherein calculating the normalized factor comprises:
determining an equity value by summing equity values of individual assets of the portfolio;
dividing the equity value by the initial portfolio value.

4. The method of claim 2, wherein further comprising:
updating the normalizing factor responsive to a change in the portfolio.

5. The method of claim 4, wherein updating the normalizing factor comprises:
calculating the updated normalizing factor using a current portfolio value, a current normalizing value and a new equity parameter associated with the change in the portfolio.

6. The method of claim 1, wherein displaying the message comprises:
displaying the message by an objective authority and responsive to determining whether the normalized change exceeds a predetermined threshold.

7. A computer program product stored on a non-transitory computer-readable medium that when executed by a processor, performs a method for tracking a normalized portfolio value, comprising:
associating a financial portfolio with a social network;
calculating a normalized change in equity value for the financial portfolio; and
displaying a message on the social network based on the calculated change.

8. The product of claim 7, wherein calculating the normalized change comprises:
calculating a normalizing factor for the portfolio based on an arbitrary initial portfolio value.

9. The product of claim 8, wherein calculating the normalized factor comprises:
determining an equity value by summing equity values of individual assets of the portfolio;
dividing the equity value by the initial portfolio value.

10. The product of claim 8, further comprising:
updating the normalizing factor responsive to a change in the portfolio.

11. The product of claim 10 wherein updating the normalizing factor comprises:
calculating the updated normalizing factor using a current portfolio value, a current normalizing value and a new equity parameter associated with the change in the portfolio.

12. The product of claim 9, wherein displaying the message comprises:
displaying the message from by an objective authority and responsive to determining whether the normalized change exceeds a predetermined threshold.

13. A system to track a normalized portfolio value, comprising:
an interface to associate a financial portfolio with a social network; and
a calculator module, coupled to the interface, the calculator module calculating a normalized change in equity value for the financial portfolio,
wherein the interface sends a message on the social network based on the calculated change.

14. The system of claim 13, wherein the calculator calculates a normalizing factor for the portfolio based on an arbitrary initial portfolio value.

15. The system of claim 14, wherein the calculator module determines an equity value by summing equity values of individual assets of the portfolio, and divides the equity value by the initial portfolio value.

16. The system of claim 15, wherein the calculator module updates the normalizing factor responsive to a change in the portfolio.

17. The system of claim 16, wherein the calculator module calculates the updated normalizing factor using a current portfolio value, a current normalizing value and a new equity parameter associated with the change in the portfolio.

18. The system of claim 13, wherein the interface sends the message from an objective authority and responsive to determining whether the normalized change exceeds a predetermined threshold.
